(19) United States
(12) Patent Application Publication
(10) Pub. No.: US 2007/0271729 A1
(43) Pub. Date: Nov. 29, 2007

(54) Dynamic Support Means For Appliances Such as Refrigerators, Freezers and the Like

(75) Inventors: Augusto Ribolzi, Travendona Monate (IT); Andrea Girardello, Malnate (IT)

Correspondence Address: MCGARRY BAIR PC, 32 Market Ave. SW, SUITE 500, GRAND RAPIDS, MI, 49503, US

(73) Assignee: WHIRLPOOL CORPORATION, Benton Harbor, MI (US)

(21) Appl. No.: 10/598,954

(22) PCT Filed: Mar. 4, 2005
(86) PCT No.: PCT/EP05/50982

§ 371 Date: Apr. 16, 2007

(30) Foreign Application Priority Data
Mar. 16, 2004 (IT) MI2004U000106

(51) Int. Cl. B60B 33/04

(52) U.S. Cl. 16/19

(57) ABSTRACT

A dynamic support means for household electrical appliances such as refrigerators, freezers or the like, comprising a support roller (13) presenting a horizontal rotation axis (b) arranged to rotate about a vertical swivel axis (a) perpendicular to it, said rotation axis (b) and said swivel axis (a) intersecting each other.

The present invention relates to a dynamic support means for appliances such as refrigerators, freezers and the like in accordance with the introduction to the main claim.

On particular occasions heavy appliances such as refrigerators, freezers and the like need to be moved from the position in which they habitually lie.

This operation is often difficult as generally these appliances are provided only with static support means such as feet or the like, generally four in number. Such movement is even more difficult when the appliances are full.

The known art has solved this problem by providing the heavier and more costly appliances with at least one pair of fixed axis rollers disposed generally at the rear of their base. However the usual static feet remain at the front. Hence, by lifting the front of the appliance its weight is almost totally discharged onto the rear rollers, so simplifying movement.

The fixed axis rollers have however the considerable drawback of urging the appliance to move along only one direction, hence not allowing easy movement in other directions.

Another drawback is that fixed axis rollers cannot be adjusted in height at will. Hence they cannot compensate for any level differences in the support surface, making the appliance unstable.

Height adjustable casters do however exist; these dynamic support means present a vertical rotation axle offset from the point at which the caster rests on the ground. In this manner, within the support means a moment is generated that tends to considerably stress the material of which the vertical rotation axle is constructed. The greater the weight acting on the support means, the greater the stress on the axle. In the case of appliances such as freezers and refrigerators the weight is such that very strong materials such as steel would have to be used. The use of such means is therefore not desirable given that it would considerably influence the overall production cost of the appliance.

An object of the present invention is therefore to provide a dynamic support means for appliances such as freezers, refrigerators and the like which represents an improvement over the known art, in the sense that it is able to withstand the weight of such appliances while being of plastic construction, and is of variable orientation.

Another object of the present invention is to provide a dynamic support means for appliances such as freezers, refrigerators and the like which is swivel-mounted, is height-adjustable, is simple from the constructional viewpoint, and is reliable.

This and further objects are attained by a dynamic support means for appliances such as freezers, refrigerators and the like in accordance with the technical teachings of the accompanying claims.

Further characteristics and advantages of the invention will be apparent from the description of a preferred but non-exclusive embodiment of the dynamic support means for appliances such as freezers, refrigerators and the like, illustrated by way of non-limiting example in the accompanying drawings, in which:

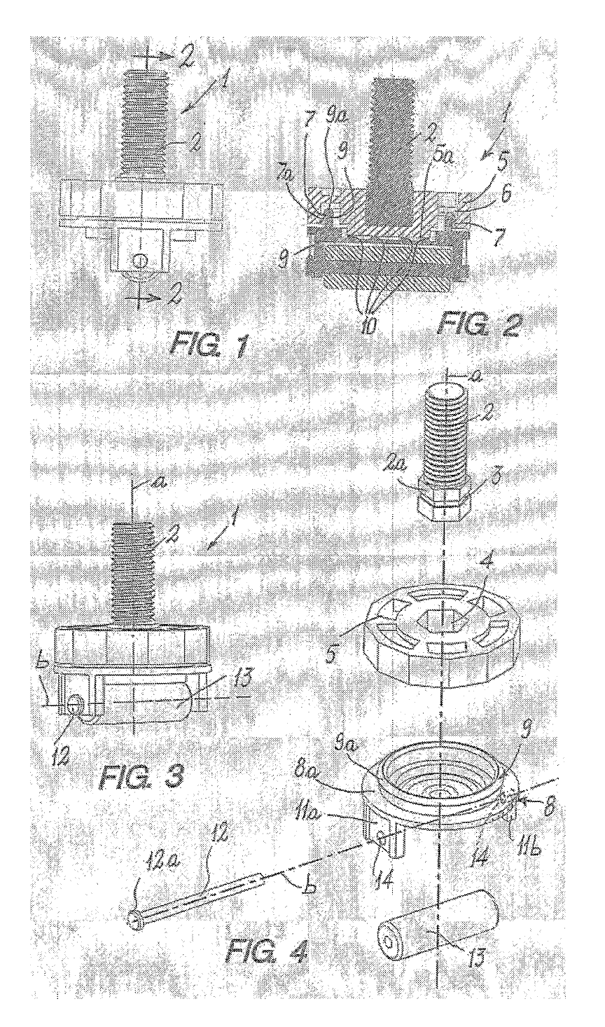

FIG. 1 is a side view of an orientatable and height-adjustable support means according to the present invention;

FIG. 2 is a section on the line 2-2 of FIG. 1;

FIG. 3 is a perspective view of the support means of FIG. 1; and

FIG. 4 is an exploded view of the invention.

With reference to FIG. 1, this shows the dynamic support means of the present invention, indicated overall by 1.

It comprises a threaded screw 2 cooperating with a known lead nut (not shown) rigid with the appliance base. This screw 2 presents a head 2a, for example hexagonal, in which a groove is present laterally to cause the polymer material to better adhere when injected about the screw head. When in use, the head 2a is housed in a seat 4 of a stationary element 5, the shape of the seat 4 (in the illustrated example shown hexagonal) mirrors that of the head 2a in order to prevent mutual rotation between the two parts. The seat 4 and head 2a are bonded together by co-moulding. In its lower face, the stationary element 5 presents an annular groove 6 provided with a facilitation step 7, possibly discontinuous.

The annular groove 6 and facilitation step 7 cooperate with an annular appendix 9, also provided with an externally projecting step 9a and projecting from the upper face 8a of a rotary element 8. The flare 7a of the facilitation step 7 is particularly useful in assembling the components, and in particular when elastically snap-fitting the annular appendix 9 into the annular groove 6.

The annular appendix 9, the annular groove 6 and the respective steps 7, 9a cooperate to mutually centre and secure the stationary element 5 and rotary element 8, in order to enable it to rotate relatively about the geometrical axis “a” of the screw 2. Annular projections 10, preferably of self-lubricating material, preferably teflon, present on the bottom face of the rotary element 8, reduce friction by sliding on the lower face 5a of the stationary element 5, to enable mutual rotation even if loaded by a large weight.

Finally, the rotary element 8 presents a pair of parallel projecting holed cheeks 11a and 11b for confining and supporting a shaft 12 about which a floor contacting roller 13 rotates. The shaft 12 is inserted with light interference into the holes 14, the roller 13 rotating idly on it. The shaft can be retained by a split pin mounted in a groove, not shown, of said shaft, in a position opposite the relative head 12a.

The swivel axis (a) of the rotary element 8 (axis coinciding with that of the screw 2) intersects perpendicularly the rotation axis (b) of the roller 13, at its centre.

The operation of the invention is apparent from the description, the height of the support means being adjusted by rotating the screw 2 by acting for example manually on the stationary element 5, rotation of the roller 13 about the vertical axis “a” being obtained by mutual rotation of the stationary element 5 and rotary element 8.

A support means conceived in this manner is particularly advantageous as the weight distributed on the floor via the roller 13 generates no moment within the support means itself, the support means hence being stressed mainly by compression. This is particularly advantageous as such a support means can be of small dimensions and constructed entirely of engineering polymer, such as ABS.

A preferred embodiment has been illustrated, however others can be conceived using the same inventive concept.

1. A dynamic support means for household electrical appliances such as refrigerators, freezers or the like, comprising a support roller (13) presenting a horizontal rotation axis (b) arranged to rotate about a vertical swivel axis (a) perpendicular to it, characterised in that said rotation axis (b) and said swivel axis (a) intersect each other.

2. A dynamic support means as claimed in claim 1, characterised in that said rotation axis (b) and said swivel axis (a) intersect each other at an intermediate point of said roller (13).

3. A dynamic support means as claimed in claim 1, characterised by presenting screw means (2) for adjusting the height of said support roller (13).

4. A dynamic support means as claimed in claim 1, characterised by comprising a rotary element (8) for supporting said roller (13) and a stationary element (5) rigid with the appliance, said elements rotating mutually about said swivel axis (a).

5. A support means as claimed in claim 4, characterised in that said rotation element (8) presents an annular appendix (9) arranged to cooperate with an annular groove (6) of said stationary element (5) to centre the two elements (5, 8).

6. A support means as claimed in claim 5, characterised in that said annular groove (6) and said annular appendix (9) present respective steps (9a, 7) for elastic constraint between the rotary element (8) and stationary element (5).

7. A means as claimed in claim 6, characterised in that said step (7) of said annular groove (6) is discontinuous.

8. A means as claimed in claim 4, characterised in that projections (10) of self-lubricating material are present between the stationary element (5) and the rotation element (8).

9. A means as claimed in claim 8, characterised in that said self-lubricating material is teflon.

10. A means as claimed in claim 4, characterised in that said support roller (13) rotates idly about a shaft (12) engaged in holes (14) provided in projections extending lowerly from said rotation element (8).
